(19) United States
(12) Patent Application Publication
(10) Pub. No.: US 2026/0144358 A1
(43) Pub. Date: May 28, 2026

(54) PVA cleaning brush

(71) Applicant: Chungeng Xie, Gao'an (CN)

(72) Inventor: Chungeng Xie, Gao'an (CN)

(21) Appl. No.: 18/960,917

(22) Filed: Nov. 26, 2024

(51) Int. Cl. A46B 5/00; A46B 15/00; A46D 1/00; B25G 3/12

(52) U.S. Cl. CPC A46B 5/0095; A46B 15/0095; A46D 1/0207; B25G 3/12; A46B 2200/3033

(57) ABSTRACT

This application relates to the technical field of cleaning brushes, and specifically discloses a PVA cleaning brush: comprising a handle, a brush head connecting part and a brush head, wherein the handle and the brush head connecting part are connected in a detachable manner, and one end of the brush head is connected to the brush head connecting part; the brush head comprises a brush head fixing part and PVA bristles, the brush head fixing part is provided with PVA bristles, and the tail of the brush head fixing part is connected to the brush head connecting part; the PVA bristles are very soft after absorbing water, and will not damage the surface of the product when cleaning an object.

### FIELD OF THE INVENTION

The present application relates to cleaning brushes. More specifically, the present application relates to PVA cleaning brush.

### BACKGROUND

We clean various items around the house daily, including furniture, electronic instruments, glassware, and more, to maintain a tidy environment. Many rely on traditional cleaning tools such as rags, nylon, and sponge brushes. However, these conventional tools have several limitations: they often struggle to clean items with uneven surfaces effectively, the bristles do not absorb water well, and they can easily scratch surfaces, leading to damage. Additionally, they may not provide thorough cleaning, leaving hard-to-reach areas neglected. This can result in water stains and other residues, which attract dust and cause secondary pollution. When using rags to clean electronic instruments, glassware, and similar items, it's common for lint to be left behind, complicating the cleaning process and dirtying your hands.

Therefore, a more sophisticated and safe cleaning tool is needed.

### SUMMARY

This application aims to solve the issues of existing technology by providing a PVA cleaning brush.

To address the technical issues mentioned above, the proposed solution is a PVA cleaning brush. This brush consists of a handle, a connector for the brush head, and the brush head itself. The handle is detachable from the brush head connector, and one end of the brush head is attached to this connector.

The brush head comprising a fixing part and PVA bristles, which are distributed across the fixing part. The tail of the fixing part is connected to the brush head connecting portion.

As an improvement, the brush head fixing component is now made from two stainless steel wires twisted together, with PVA bristles secured tightly in the space between them. This modification ensures a more secure attachment. Additionally, a slot has been created at the front end of the brush head connecting portion. The tail of the stainless steel wire from the brush head fixing component is inserted into this slot. Before insertion, the slot is heated to soften it slightly, making it easier to insert the tail wire. Once the slot cools, it firmly bonds with the brush head fixing component.

As an improvement, a plug-in groove is located at one end of the handle, which connects to a fixing groove on the handle itself. At the rear end of the brush head connection, there is a plug-in sleeve that fits into the plug-in groove. The plug-in sleeve features a notch, and an elastic sheet is positioned on the inner wall of this notch. At the tail end of the elastic sheet, there is a limiting protrusion that engages with the fixing groove.

As an improvement, the handle is provided with a hanging ring at the tail.

The advantages of the present application compared with the prior art are:
1. The PVA bristles become very soft after absorbing water, ensuring that the surfaces of electronic precision instruments, glassware, and other items are not damaged during cleaning. Additionally, PVA has a strong water absorption capacity, capable of holding 4-5 times its own weight in water. It can absorb water without dripping, leaving no water stains after wiping the surface of an object. This makes it effective for cleaning uneven surfaces without the concern of leaving areas uncleaned, thereby enhancing the overall cleaning effect. Furthermore, PVA demonstrates strong dust absorption, capturing dust particles without redistributing them into the air, which helps prevent secondary pollution during the cleaning process.
2. The brush head is securely bonded to the connection part, ensuring a firm fit that prevents the brush head from detaching during 360-degree cleaning. This design allows the PVA cleaning brush to effectively clean objects with uneven surfaces, resulting in a more comprehensive and thorough cleaning experience and significantly improving the overall cleaning effectiveness.
3. The handle and the brush head are connected in a detachable manner, allowing for easy replacement of the brush head. This feature not only lowers the overall cost of use but also minimizes waste, making it environmentally friendly and resource-efficient.

### BRIEF DESCRIPTION OF THE DRAWINGS

FIG. 1 is a front view of the PVA cleaning brush;

FIG. 2 is a perspective view of the PVA cleaning brush;

FIG. 3 is a schematic diagram of the structure of a PVA cleaning brush head connecting portion and brush head;

FIG. 4 is a cross-sectional view at A-A in FIG. 1;

FIG. 5 is a perspective view of a PVA cleaning brush handle of the present invention; and

FIG. 6 is an enlarged view of B, from FIG. 4.

The technology may be more completely understood in connection with the following drawings, in which:
100. handle
101. plug-in groove
102. fixing groove
103. hanging ring
200. brush head connecting portion
201. plug-in cylinder
202. notch
203. elastic sheet
204. limiting protrusion
205. slot
300. brush head
301. brush head fixing portion
302. PVA bristles

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

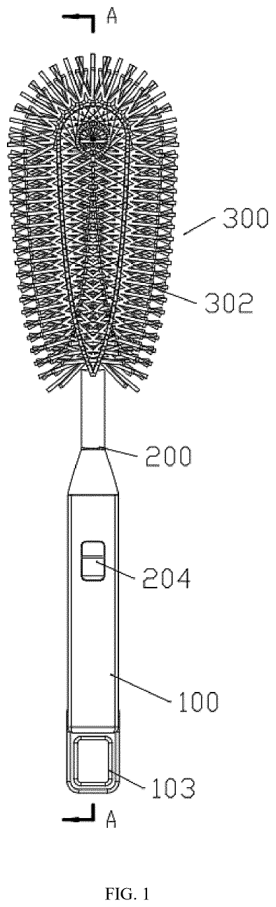

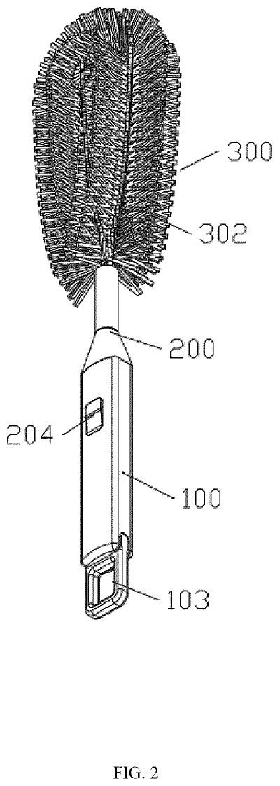

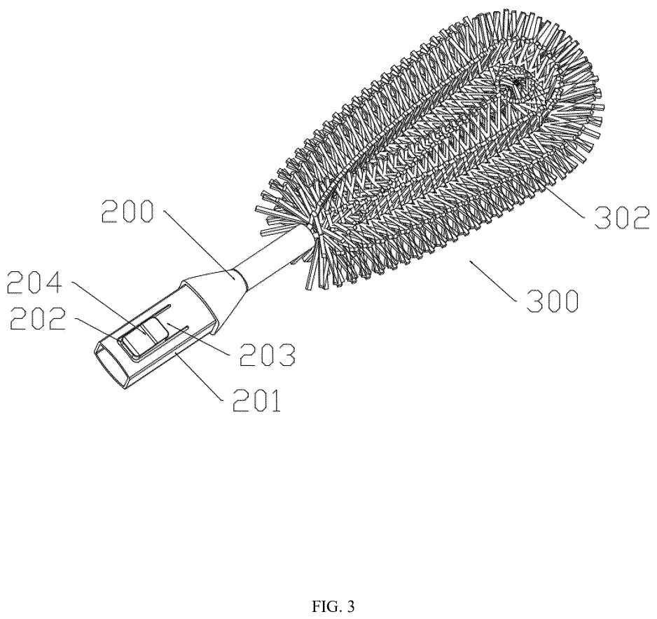

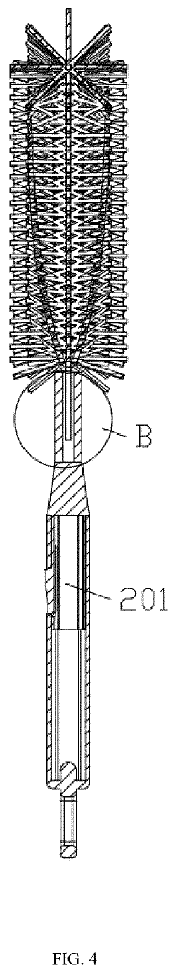

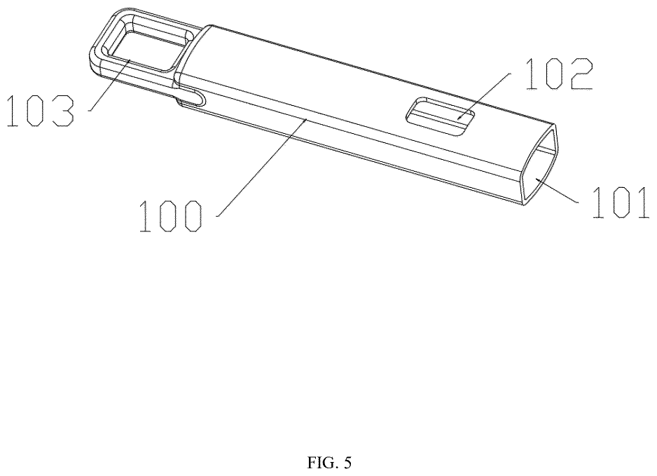

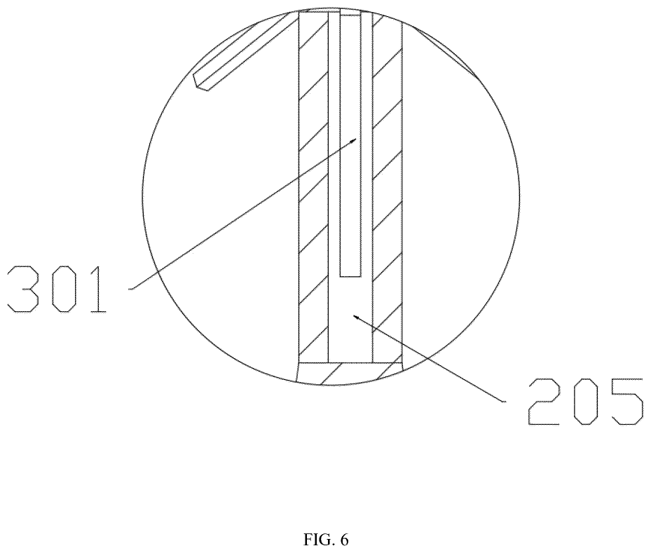

As shown in FIGS. 1-6, a PVA cleaning brush comprises a handle 100, a brush head connecting portion 200 and a brush head 300, wherein the handle 100 and the brush head connecting portion 200 are connected in a detachable manner, and one end of the brush head 300 is connected to the brush head connecting portion 200.

The brush head 300 comprises a brush head fixing portion 301 and PVA bristles 302. The PVA bristles 302 are distributed on the brush head fixing portion 301. The tail of the brush head fixing portion 301 is connected to the brush head connecting portion 200.

Specifically, the brush head connecting portion 200 is made of two stainless steel wires wound together, and the PVA bristles 302 are sandwiched in the gap between the two wound stainless steel wires, so that it is fixed more firmly; secondly, a slot 205 is provided at the front end of the brush head connecting portion 200, and the tail stainless steel wire of the brush head connecting portion 301 is inserted into the slot 205, and before plugging in, the slot is heated to soften it appropriately, and then the tail stainless steel wire of the brush head connecting portion 301 can be easily inserted into the slot 205, and after the slot is cooled, it will be firmly bonded to the brush head connecting portion; thereby achieving a 360-degree cleaning effect without dead ends, so that the PVA cleaning brush can clean objects with uneven surfaces more comprehensively and thoroughly, thereby improving the cleaning effect; secondly, the PVA bristles 302 will be very soft after absorbing water, which is convenient for cleaning objects, and has strong water absorption and dust absorption, so that it can clean more thoroughly

A plug-in groove 101 is provided inside one end of the handle 100, and a fixing groove 102 connected to the plug-in groove 101 is provided on the handle 100. A plug-in cylinder 201 is provided at the rear end of the brush head connecting portion 200, and the plug-in cylinder 201 cooperates with the plug-in groove 101 to achieve a stable connection between the two; a notch 202 is provided on the plug-in cylinder 201, and an elastic sheet 203 is provided on an inner wall of the notch 202, and a limiting protrusion 204 is provided at the tail end of the elastic sheet 203, and the limiting protrusion 204 cooperates with the fixing groove 102. During plugging, when the plug-in cylinder 201 is fully inserted into the plug-in groove 101, the limiting protrusion 204 is rebounded into the fixing groove 102 under the action of the elastic sheet 203, thereby locking the connection between the brush head connecting portion 200 and the handle 100; in addition, a hanging ring 103 is provided at the tail end of the handle 100, which is convenient for users to hang and store it when not in use.

When used, the assembly process is:
First, align the plug-in cylinder 201 of the brush head connecting portion 200 with the plug-in groove 101 of the handle 100, and push it in forcefully until the plug-in cylinder 201 completely enters the plug-in groove 101; during this process, the limiting protrusion 204 on the elastic sheet 203 will be squeezed by the inner wall of the plug-in groove 101, and the elastic sheet 203 will be pressed down, so that the elastic sheet 203 is pressed down, and when the plug-in cylinder 201 is completely in place, the limiting protrusion 204 reaches the position of the fixing groove 102, and the pressure on the limiting protrusion 204 will be released, and the elastic sheet 203 will return to its original state, driving the limiting protrusion 204 to bounce into the fixing groove 102, thereby locking the connection.

Usage process:
First, wet the PVA bristles 302 to absorb water, then twist off the water to keep the PVA bristles 302 moist. The PVA bristles 302 will be very soft when moist, making it easier to wipe items. Then the user can hold the handle 100 and use the PVA bristles 302 for cleaning;

The excellent water absorption, dust absorption and decontamination capabilities of PVA bristles 302 make the cleaning process more efficient and thorough.

Disassembly and maintenance:
When the brush head 300 needs to be replaced or cleaned, the user only needs to gently press the elastic sheet 203 to make the limiting protrusion 204 disengage from the fixing groove 102, and then the handle 100 and the brush head connecting portion 200 can be easily separated, and then the brush head 300 and the brush head connecting portion 200 can be replaced as a whole, or the PVA bristles 302 can be cleaned.

1. A PVA cleaning brush, comprising a handle, a brush head connecting portion and a brush head, wherein the handle and the brush head connecting portion are connected in a detachable manner, and one end of the brush head is connected to the brush head connecting portion;
wherein the brush head comprises a brush head fixing portion and PVA bristles, the PVA bristles being distributed on the brush head fixing portion, and the tail of the brush head fixing portion being connected to the brush head connecting portion.

2. The PVA cleaning brush of claim 1, wherein a plug-in groove is provided inside one end of the handle, a fixing groove connected to the plug-in groove is provided on the handle, a plug-in cylinder is provided at the rear end of the brush head connecting portion, the plug-in cylinder cooperates with the plug-in groove, a notch is provided on the plug-in cylinder, an elastic sheet is provided on an inner wall of the notch, a limiting protrusion is provided at the rear end of the elastic sheet, the limiting protrusion cooperates with the fixing groove.

3. The PVA cleaning brush of claim 1, wherein the handle is provided with a hanging ring at the rear end.
